(19) United States
(12) Patent Application Publication
(10) Pub. No.: US 2020/0128364 A1
(43) Pub. Date: Apr. 23, 2020

(54) Improved Isolated Group Communications

(71) Applicant: Telefonaktiebolaget LM Ericsson (publ), Stock (SE)

(72) Inventors: Magnus Tränk, Lerum (SE); Joakim Åkesson, Landvetter (SE)

(21) Appl. No.: 16/070,364

(22) PCT Filed: Jun. 20, 2018
(86) PCT No.: PCT/EP2018/066378

§ 371 Date: Jul. 16, 2018

(51) Int. Cl. H04W 4/08; H04W 4/10; H04W 8/24; H04W 76/30; H04W 4/90

(52) U.S. Cl. CPC H04W 4/08; H04W 4/10; H04W 4/90; H04W 76/30; H04W 8/24

(57) ABSTRACT

A method in a Group Communications, GC, server node comprising a central GC server, wherein the central GC server comprises a central participating function and a central controlling function for GC involving a GC client. The method comprises obtaining information indicating whether the GC client is in proximity of a GC capable radio base station, RBS, and, if the GC client is in proximity of the GC capable RBS, handling GC involving the GC client by the central controlling function and releasing the central participating function to the GC capable RBS that is adapted to execute a local participating function.

### TECHNICAL FIELD

The present disclosure relates to group communications in communication networks, and to mission critical network services. The disclosure also relates to Isolated E-UTRAN Operations for Public Safety (TOPS).

### BACKGROUND

Mission Critical (MC) communication services are essential for the work performed by public safety users such as police and fire brigade personnel. The MC communications service requires preferential handling compared to normal telecommunication services including handling of prioritized MC calls for emergency and imminent threats. Furthermore, MC communication services require several resilience features that provide a guaranteed service level even if part of the network or backhaul infrastructure fails.

The most commonly used communication method for public safety users is Group Communication (GC) where the same information is delivered to multiple users. One type of Group Communication is Push to Talk (PTT) service. A Group Communication system can be designed with a centralized architecture approach, in which a centralized GC control node provides full control of all GC service data, such as group membership, policies, user authorities and prioritizations. Such an approach requires a network infrastructure that provides high network availability. This type of operation is sometimes known as Trunked Mode Operation (TMO) or on-network operation.

A different approach is a design where each user radio device or a sub-set of user radio devices are taking part in controlling the group communication. In this case, the GC service data, and/or group data, must be pre-provisioned to each device. This type of solution is sometimes known as Direct Mode Operation (DMO) or off-network operation, which means that GC can take place without any support, or with limited support, from network infrastructure.

In existing GC systems both approaches mentioned above are often supported. Furthermore, existing GC systems may provide a resilience feature that allows a local radio base station to provide local connectivity and GC to users in proximity of the local radio base station, even if the local radio base station loses it connections to other parts of the network. This is in some deployments known as Local Site Trunking.

In a 3GPP based network that provides GC services like Mission Critical Push To Talk (MCPTT), the service can be guaranteed even in the case of backhaul failure by using a feature known as Isolated E-UTRAN Operations for Public Safety (IOPS). This feature is described in, e.g., 3GPP TS 23.401 v15.1.0, Annex K. The IOPS functionality provides local connectivity to the public safety users' devices that are within communication range of the E-UTRAN radio base station (eNB) that supports IOPS.

One way to provide IOPS in a 3GPP based network is to deploy a packet core network in each radio base station, i.e., a local packet core network. This network may be an evolved packet core network (EPC). This includes a user database comprising user identities and authentication keys.

To provide GC with an acceptable service level in IOPS, as described in 3GPP TS 23.401 v15.1.0, it is required that the GC service data is synchronized between a centralized GC control node and the local GC application that resides in the radio base station that will provide the resilience feature IOPS. Additionally, user data including security materials, such as user credentials and authentication keys, must be synchronized between the centralized user database and the local radio base stations core network functionality. There may be many IOPS capable radio base stations in a network, each requiring synchronization. This results in a synchronization challenge in known GC systems using IOPS solutions or similar. Not only the amount of data is a problem, but the data must also be maintained regularly to stay relevant, and constant cross-checking between data registers is therefore necessary. Hence, there is a need for improved methods for data synchronization in GC systems.

### SUMMARY

It is an object of the present disclosure to provide improved methods and devices for efficient synchronization of GC service data and to facilitate switching between centrally managed group communications to locally managed group communications.

This object is obtained by a method in a GC server node comprising a central GC server. The central GC server comprises a central participating function and a central controlling function for GC involving a GC client. The method comprises obtaining information indicating whether the GC client is in proximity of a GC capable radio base station (RBS). The method comprises, if the GC client is in proximity of the GC capable RBS, handling GC involving the GC client by the central controlling function and releasing the central participating function to the GC capable RBS that is adapted to execute a local participating function.

Advantages associated with the disclosed methods and devices comprise significantly reduced complexity in switching between supporting the GC service from a centralized system and supporting the GC service from a local system, e.g., in IOPS operation. Runtime application dynamic data is by the disclosed method already handled by the local system prior a switch to local mode.

According to aspects, the GC capable RBS is an Isolated E-UTRAN operations for Public Safety, IOPS, capable RBS. Thus, the disclosed methods are especially suitable for use in IOPS-based GC systems.

According to aspects, the method comprises requesting re-registration involving the GC client and the GC capable RBS if the GC client is in proximity of the GC capable RBS.

This way the central GC server node may prompt a wireless device to re-register for GC involving a local GC capable RBS. This provides some control over the re-registration procedure, which is an advantage. For instance, the request for re-registration may be performed if a loss of communications to a serving GC capable RBS is imminent. Also, a re-registration to the local GC server may be forced by the central GC server, for instance in a traffic overload situation,

According to aspects, releasing the central participating function comprises obtaining confirmation that a local participating is executed by the GC capable RBS prior to releasing the central participating function.

By obtaining such confirmation, it is less likely that GC service interruption occurs when the central participating function is terminated, which is an advantage.

The object is also obtained by a method in a wireless device comprising a GC client. The method comprises obtaining information indicating whether the GC client is in proximity of a GC capable RBS, which RBS comprises a local GC server. The method also comprises, if the GC client is in proximity of a GC capable RBS, performing a GC registration procedure involving the GC client and the local GC server.

By registering with the local GC server, synchronization of data may be performed. Thus, advantageously, the synchronization problems associated with GC communication mentioned above are solved or at least alleviated. Also, by re-registering with the local GC server, preparation for a switch to local mode operation is achieved in that, e.g., the GC client context is made known to the local GC server, which facilitates a later switch to local mode operation in case of link failure.

According to aspects, the method comprises receiving a request for re-registration involving the GC client and the local GC server from a central GC server. The performing of a GC registration procedure involving the GC client and the local GC server is executed in response to receiving the request for re-registration.

As noted above, this provides control over the re-registration procedure, which is an advantage. For instance, the request for re-registration may be performed if the wireless device is in proximity of the GC capable RBS and can by that maintain the communication in case the RBS loses connectivity to the central GC server. This also simplifies design of the wireless device, which no longer needs to be able to determine when to perform the registration procedure with the local GC server.

According to aspects, the method comprises performing a handshake procedure for group communication involving the GC client and the local GC server following a link outage between the local GC server and the central GC server, or between the GC client and the central GC server.

The handshake procedure reduces probability of service outage in that the connection procedure is made more robust to error and configuration differences between GC client and local GC server, which is an advantage.

According to some aspects, the handshake procedure comprises a transition procedure.

The object is furthermore obtained by a method in a local GC capable RBS comprising a local GC server. The local GC server comprises a local participating function and a local controlling function for GC involving a GC client comprised in a wireless device. The method comprises obtaining information indicating whether the GC client is in proximity of the GC capable RBS. If the GC client is in proximity of the GC capable RBS, then the method comprises performing a GC registration procedure involving the GC client and the local GC server, handling GC involving the GC client by the local participating function, and following a link outage between the local GC server and a central GC server, or between the GC client and the central GC server, performing a handshake procedure for group communication involving the GC client and the local GC server, and handling GC involving the GC client by the local participating function and the local controlling function.

This way the local GC capable RBS maintains synchronized data related to wireless devices in proximity of the local GC server. The local GC server supports GC by the participating function, while the central GC server executes the controlling function. When there is a link outage, then local GC operation is activated using the synchronized data and the GC client context, already available to the local GC server.

According to aspects, the method comprises transmitting an indication to the wireless device relating to a GC capability of the GC capable RBS.

Thus, the wireless device is made aware of the GC capabilities of the GC capable RBS.

Apart from the above methods, there is also disclosed herein devices and computer programs comprising computer program code corresponding to the methods. The devices and computer programs display advantages corresponding to the advantages already described in relation to corresponding above-mentioned methods.

### BRIEF DESCRIPTION OF THE DRAWINGS

The present disclosure will now be described in more detail with reference to the appended drawings, where

FIG. 1 shows a schematic view of a communication system;

FIG. 2 shows a schematic view of a network node;

FIG. 3 shows a schematic view of a wireless device;

FIG. 4 illustrates a sequence of events in a communication system according to aspects of the present disclosure;

FIG. 5 illustrates example connections in a GC system before link failure;

FIG. 6 shows a flowchart illustrating methods performed in a central server node according to aspects of the present disclosure;

FIG. 7 shows a flowchart illustrating methods performed in a wireless device according to aspects of the present disclosure;

FIG. 8 shows a flowchart illustrating methods performed in a local server node according to aspects of the present disclosure;

FIGS. 9-10 schematically illustrate a server node according to aspects of the present disclosure;

FIGS. 11-12 schematically illustrate a wireless device according to aspects of the present disclosure;

FIGS. 13-14 schematically illustrate a server node according to aspects of the present disclosure;

FIG. 15 schematically illustrates a computer readable medium; and

FIG. 16 shows a functional model for an IOPS MC system based on migration of users.

### DETAILED DESCRIPTION

Aspects of the present disclosure will now be described more fully with reference to the accompanying drawings. The different devices, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

The solutions disclosed herein comprise a distributed GC application architecture. The distributed architecture encompasses a centralized GC system, a GC client and one or more local GC systems deployed in GC capable RBSs. The local GC system may also serve one or more RBSs in proximity of the local GC system, such as RBSs within a geographically limited area. The GC architecture implements methods for GC client registration in the local system, based on the current location of the GC client, while still receiving the GC service from the centralized system.

The herein proposed solution utilizes the above-mentioned GC application architecture by distributing the control nodes that performs the participating functions to the local RBSs that support local GC. Furthermore, the GC clients will, based on location or proximity reports, register to the nearest control node that performs the participating function. With this method, the clients are already registered and utilize part of the GC function from the control node performing the participating function located in the GC capable radio base station, or in proximity of the local GC system. This way synchronization of data and the GC client context in the control node is facilitated in an efficient manner, and a robust transition from centrally supported GC to locally supported GC is enabled.

The proposed solutions and techniques provide a synchronization method between a centralized GC system, a GC client and a local GC system that is deployed in an IOPS (Isolated E-UTRAN Operations for Public Safety) capable eNodeB or similar, as discussed in, e.g., 3GPP TS 23.401 v15.1.0, Annex K. It is appreciated that, although the main concepts herein are exemplified using an IOPS system, the disclosure is not limited to use together with IOPS as described in 3GPP TS 23.401 v15.1.0 but is applicable also in similar systems involving a central server arranged to control group communications, and local servers configured to take over group communications support in case of network infrastructure failure.

A controlling function and a participating function is referred to throughout this disclosure. An example of the participating function and the controlling function is described in 3GPP TS 23.379 V.15.3.0, along with their respective purposes. It is, however, appreciated that this disclosure is not limited to these exact functions. Rather the present disclosure should be interpreted as encompassing such functions as described in 3GPP TS 23.379 V.15.3.0, and also similar functions having similar purpose in a GC system context.

Herein, data, GC data, GC service data, GC user data, and similar terms, are used interchangeably and refer to data items relevant for establishing and maintaining group communication. Such data comprises, for example, one or more of: group membership, group affiliations, policies, user authorities, prioritizations, authorization keys, and the like. For example, an important communication type is Mission Critical (MC) Push To Talk (PTT) services. A complete MCPTT system requires extensive user, service, and group configuration data, herein all referred to as GC service data. In an MCPTT system compliant with 3GPP TS 23.179 V13.5.0 there is an MCPTT user profile defined with several parameters, that controls one or more of the: user access, service settings, contact list, authorization parameters etc. There is also group configuration that includes one or more of: group identities, group memberships, group call control attributes like affiliation statues and prioritizations. GC service data refers, e.g., to such data items.

GC data, such as GC service data and GC client data, may comprise both persistent data and dynamic data. Persistent data may also be referred to as static data, or permanent data. Dynamic data is sometimes referred to as volatile data.

GC context data is an example of dynamic data, which may change over time. Dynamic data is volatile in the sense that it is created on-demand and not stored permanently. Further examples of dynamic data comprise IP addresses, port numbers, encryption keys, and geographical locations.

Permanent data is persistently stored. Examples of persistent data comprise MAC addresses, mobile subscriber identities, public user identities, and phone numbers.

Herein, the term proximity is given a broad interpretation to mean geographical proximity, and also network proximity. Thus, two devices located in the same part of a network, e.g., in the same IP sub-net or domain served by the same core network section can be in proximity to each other even though the geographical distance is large. Also, a part of a network may become isolated from other parts of the network when the infrastructure fails at some point.

However, those isolated network nodes and wireless devices may be distributed across a geographically large area, depending on network configuration. Therefore, a wireless device located geographically close to a network node may or may not be in proximity of the network node, depending on how the network is configured.

According to aspects, GC service data comprises 3rd party registration data transferred during a 3rd party registration procedure. This type of data is discussed, e.g., in Internet Engineering Task Force (IETF) RFC 3261-SIP: Session Initiation Protocol. 3rd party registration data and procedures in the context of group communication systems are known and will not be discussed in detail here. It is, however, appreciated that the central GC server may advantageously make use of 3rd party registration mechanisms when transferring GC service data to a local GC server.

3GPP TS 23.179 v13.5.0 discusses group affiliations in relation to group communications. In general, group affiliations relate to a mechanism by which, e.g., an MCPTT users interest in one or more MCPTT groups is determined.

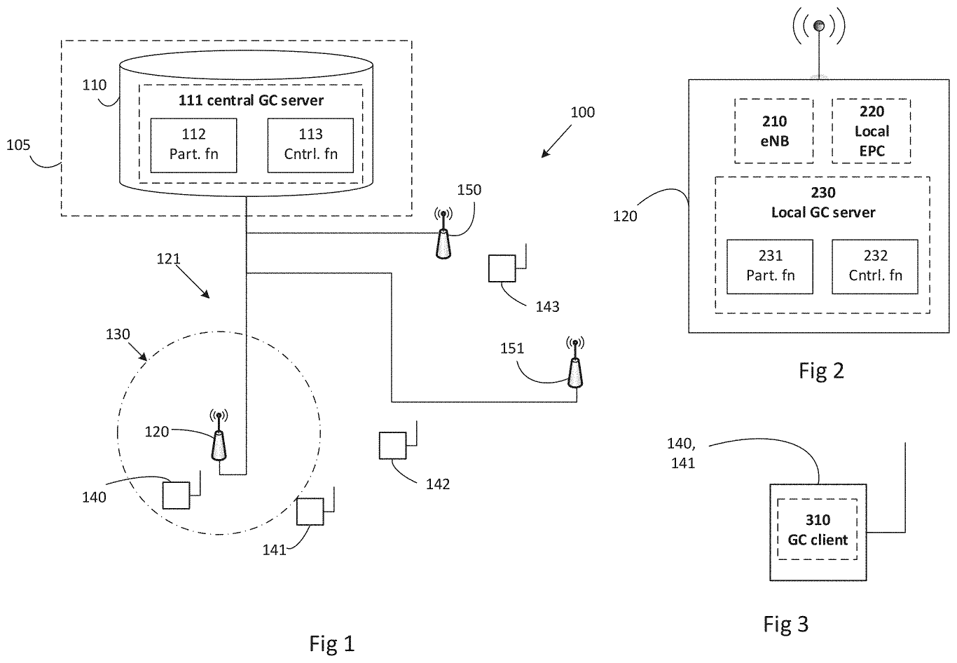

FIG. 1 shows a schematic view of a communication system 100 where the concepts disclosed herein are applicable. A number of wireless devices 140, 141, 142, 143 are located throughout an area comprising a number of radio base stations 120, 150, 151. The radio base stations are connected via, e.g., backhaul communication links 121 to a core network 105.

The core network 105 comprises a GC server node 110, which implements or comprises a central GC server 111. The central GC server manages group communications in the area. For instance, the central GC server maintains updated GC service data necessary for providing GC services throughout the area.

The central GC server comprises a participating function 112 and a controlling function 113. These functions may correspond to participating and controlling functions discussed in 3GPP TS 23.379 V.15.3.0 but may also correspond to functions having similar purpose in other GC systems.

The different radio base stations are associated with respective coverage areas 130. A wireless device 140 located within a coverage area 130 is able to communicate to and/or from the radio base station. According to some aspects, a wireless device located within the coverage area of an RBS is in proximity of the RBS.

The backhaul communication link 121 may fail due to various reasons. If this happens, the radio base station 120 may lose connectivity to the central GC server 111 and will then be isolated from the central GC system. If no action is taken, GC service in the coverage area of the isolated radio base station may be affected.

A radio base station resilience feature known as IOPS is known, especially in relation to public safety users such as police and fire brigade personnel. IMPS is discussed in, e.g., 3GPP TS 23.401 v15.1.0 Annex K. The IOPS feature can provide local connectivity to the wireless devices 140, 141, in the case when there is a link failure to the core network 105. The IOPS feature can be used in different types of deployments. One common scenario is when radio base station 120 is located on a remote location (e.g. an island) and the radio base station is connected to the core network via e.g. a satellite link. If there is a satellite link failure, it is critical for Public Safety users to be able to at least have local connectivity for the communication between the users in the coverage 130 of the radio base station 120.

To public safety users an important communication type is Group Communication (GC), for example Mission Critical Push To Talk (MCPTT) services. A complete MCPTT system requires extensive user, service, and group configuration data, potentially including both dynamic and static data, herein referred to as GC service data, as discussed above.

When using IOPS or similar there is a need for a local GC system that can serve the users. This serving requires that the database of the local GC system is synchronized, or sufficiently synchronized, with the centralized GC system which is used when IOPS or similar is not active. The synchronization of user/service data is complex both due to the extensive data model, but also due to the large number of radio base station that should support IOPS. There is also a need to have the GC client context or registration state being synchronized between the centralized GC system comprising the central GC server 111 and the local GC system comprising the local GC server 230.

FIG. 2 shows a schematic view of a network node 120. The network node 120 exemplifies the network node 120 shown in FIG. 1. This network node 120 comprises an eNB 210, a local evolved packet core (EPC) 220 and a local GC server 230. This local GC server comprises a local participating function 231 and a local controlling function 232. An example of the participating function and the controlling function, valid for both local 231, 232 and central 112, 113 functions, is described in 3GPP TS 23.379 V.15.3.0, along with their respective purposes. It is, however, appreciated that this disclosure is not limited to these exact functions. Consequently, the local participating function 231 corresponds to the central participating function 112, and the local controlling function corresponds to the central participating function 113.

FIG. 3 shows a schematic view of a wireless device 140, 141. The wireless device exemplifies wireless devices 140, 141 in FIG. 1. The wireless device 140 comprises a GC client 310. For example, the wireless device may be capable of MCPTT or similar. Wireless device 140 is within radio coverage of the network node 120 and may thus benefit from local GC support by the network node 120. Wireless device 141 is in geographical proximity of the network node 120 and may thus benefit of local GC support in case it moves into radio coverage of the network node 120.

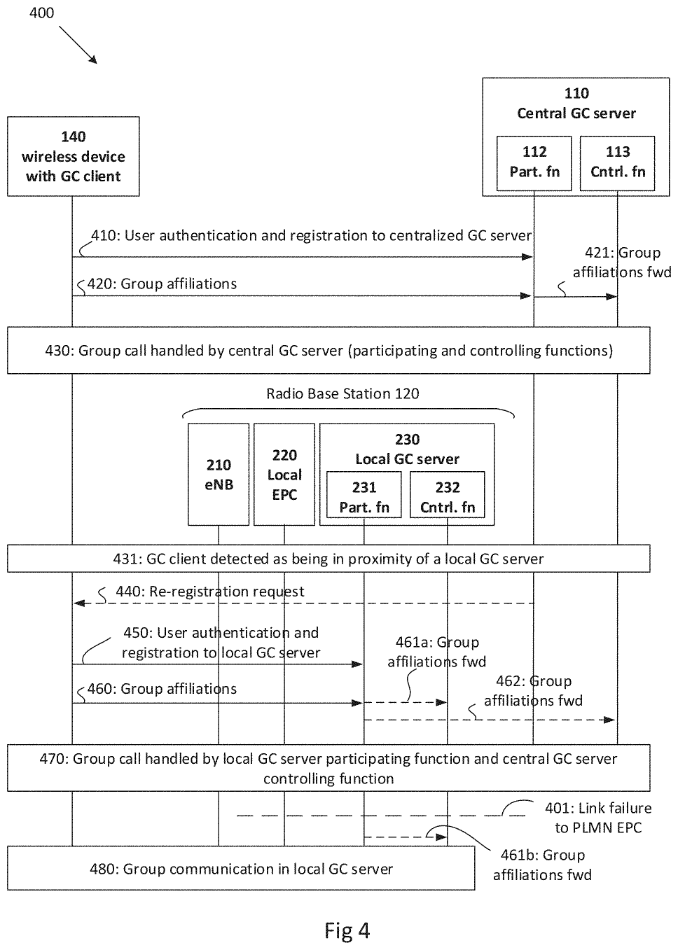

FIG. 4 illustrates an example sequence of events 400 in a communication system 100 according to aspects of the present disclosure. There is shown an exchange between a wireless device 140 a radio base station 120 and a central GC server 110. The wireless device comprises a GC client. The radio base station 120 comprises an eNB 210, a local EPC 220, and a local GC server 230. The local GC server 230 comprises the local participating function 231 and the local controlling function 232 discussed above in connection to FIG. 1.

The method is performed both prior and after a link failure 401 between the Radio Base Station 120, and the centralized public land mobile network (PLMN) core network, i.e., before connection 121 to the central GC server 111 is lost.

Herein, link failure refers to any event which interrupts or negatively affects the ability of the central GC server to provide GC support. It can for instance be a physical link failure due to a broken optical fiber link, or it can be a reduced throughput condition over a microwave link due to heavy rain, or it can be a partial network outage condition due to a network configuration error.

In general, it is appreciated that a link failure or backhaul link failure may isolate parts of a network from other parts of the network. It may happen that the central GC server becomes isolated from a section of the network. The section of the network may consist of one or several RBSs. Then, as long as this section comprises the local GC server according to the discussion herein, group communications can be maintained as long as the local GC server remains connected to one or more radio base stations within radio coverage of the wireless device comprising the GC client.

With reference to FIG. 4, A GC client installed on in a wireless device 140 first performs authentication and registration procedures 410. This could for example be done based on the 3GPP MC common architecture framework described in TS 23.280 v 15.2.0. The authentication and registration procedure triggers the creation of the GC client context in the central GC server.

Following authentication and registration, the GC client affiliates 420 to all groups that the user is interested to take part in. The group affiliation data is forwarded 421 to the controlling function 113 in a known manner, i.e., the group affiliation data is passed to the controlling function 113 via the participating function. It is appreciated that, according to some aspects, the group affiliation procedure is executed directly between the GC client and the central controlling function 113.

All communication in the GC system is then handled 430 by a centralized GC server 110. The central GC server supports GC involving the GC client by both a participating function 112 and a controlling function 113.

The GC system then detects that the GC client is in the coverage of a GC capable RBS and can by that trigger the GC client to re-register to the local GC server participating function 231. This triggering or detecting is, according to different aspects, performed in different ways. For instance, the GC client may be aware of GC capable RBSs in its neighbourhood, or the RBSs may broadcast system information about GC capability, or the GC client may report its current location to the network or centralized GC server, which could instruct the GC client to perform a re-registration to the local GC system. These different options are compatible and may be performed singly or in combination. The GC system may also trigger additional GC clients (not illustrated in FIG. 4) to re-register in the same manner. For instance, the wireless device first to re-register may be a member of a group, in which most affiliated group members are in the coverage of the GC capable radio base station. It may in certain circumstances be suitable that all GC clients in a group re-registers to the same local GC server participating function 231 is possible.

Optionally the centralized GC server 110 may inform the GC client about the proximity of a GC capable radio base station and request 440 the GC client to re-register to a local GC server participating function. This message may also be sent to other GC clients in proximity of the GC capable RBS, and also to wireless devices that potentially will be within coverage of the GC capable RBS later on. This decision could for example be based on group affiliations or group memberships.

The GC client now performs authentication and registration procedures 450, but towards the local GC server participating function. With this step the GC client context and registration data is kept and stored in the local GC server 230, which is maintained during a transition to local GC mode, such as an IOPS mode. The authentication and registration procedures 450 could for example be done based on the 3GPP MC common architecture framework described in TS 23.280 v 15.2.0.

Following authentication and registration with the local GC server 230, the GC client affiliates 460 to all groups that the user is interested to take part in. The group affiliation data is optionally transferred 461a to the local controlling function 232 directly following group affiliation 460, i.e., prior to any link failure 401 or local mode operation 480. However, the group affiliation data can optionally also be forwarded after link failure 461b, i.e., as local mode operation is started.

The group affiliation data is optionally also forwarded 462 to the central controlling function 113.

The GC is now partly supported by the local GC server 230. The participating function is executed locally 231, while the controlling function is executed centrally 113.

The local system may lose the connection towards the network infrastructure and by that lose the connectivity towards the centralized GC server, i.e., there is a link failure 401. All communication towards the GC client is then handled by the local GC server operating in local GC mode. This means that both the participating function 231 and the controlling function 232 are executed by the local GC server 230.

It is noted that FIG. 4 only shows one RBS that is GC capable. However, in a network there might be several RBSs that are GC capable. There may also be several RBSs that have connectivity to one local EPC 220 and a local GC system or server 230, i.e., several RBSs may be in proximity of a local EPC and a local GC server 230.

A central concept behind the solution exemplified in FIG. 4 is to provide an optimized central GC to local GC transition, by utilizing a split application architecture and trigger GC clients to register to a local GC server control node when the GC client is in proximity or in coverage of the GC capable RBS, or by other means (e.g. that the GC client is a member of a group, in which most affiliated group members are in the coverage of the IOPS capable radio base station).

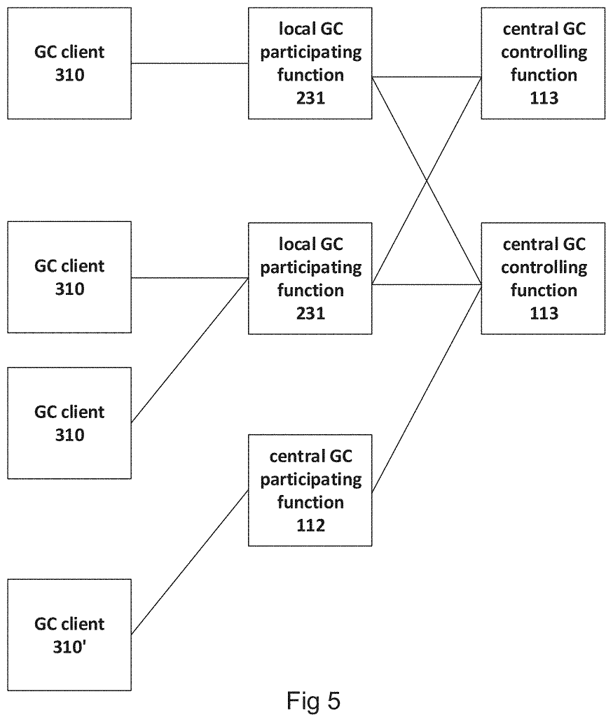

FIG. 5 illustrates connections in a GC system prior to link failure. One or more GC clients 310 are connected to local GC participating functions 231 comprised in local GC servers 230. However, as long as there is a connection active to the central GC server 110, then the controlling function 113 is executed centrally by the central GC server 113. It is appreciated that some GC clients 310′ may be supported by the central GC participating function 112 and central controlling function 113. I.e., a central GC server 111 may support come GC clients by the controlling function only, and some other GC clients by both participating function and controlling function.

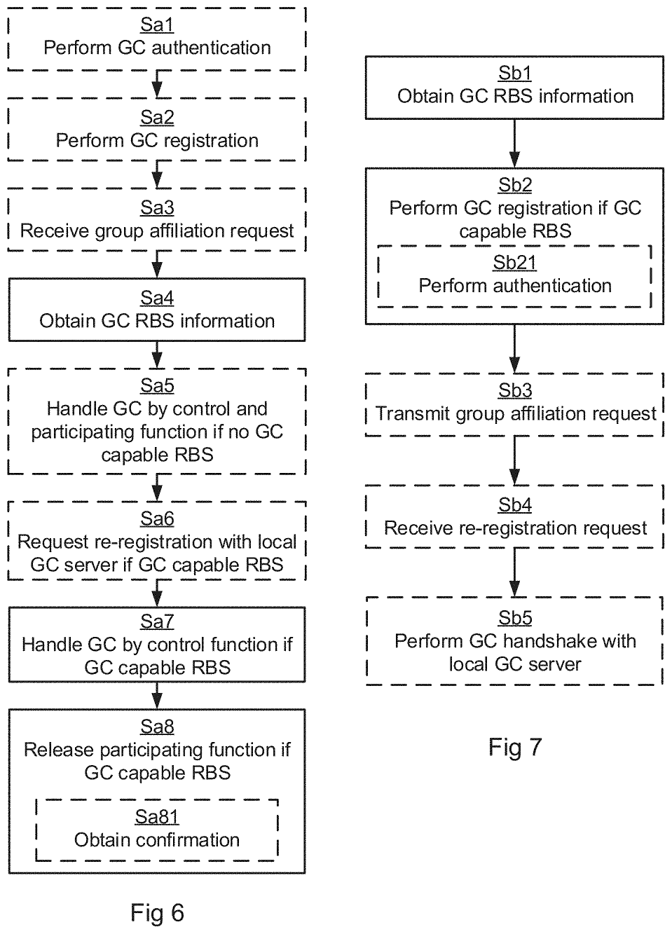

FIG. 6 is a flow chart illustrating a method in a GC server node 110, such as the GC server node discussed in connection to FIGS. 1-5. The GC server node comprises a central GC server 111. This central GC server comprises a central participating function 112 and a central controlling function 113 for GC involving a GC client 310. Non-limiting examples of the participating function and the controlling function are given in 3GPP TS 23.379 V.15.3.0. The method comprises obtaining Sa4 information indicating whether the GC client 310 is in proximity of a GC capable radio base station 120, RBS. The method comprises, if the GC client is in proximity of the GC capable RBS, handling Sa7 GC involving the GC client 310 by the central controlling function 113 and releasing Sa8 the central participating function 112 to the GC capable RBS 120 that is adapted to execute a local participating function 231.

Thus, when a GC client enters in proximity of a GC capable RBS comprising a local GC server, such as an IOPS capable RBS, then the participating function is handed over to the local GC server, while the controlling function is maintained at the central GC server. Advantages associated with this method comprise significantly reduced complexity in switching between receiving the GC service from a centralized system and receiving GC service from a local GC system comprised in a GC capable RBS. Runtime application dynamic data, e.g. GC client context, is already handled by the local system prior a switch to local GC mode, such as an IOPS mode, and can by that be maintained during GC in local mode

According to aspects, the method comprises performing Sal an authentication procedure involving the GC client 310. This could for example be done based on the 3GPP MC common architecture framework, ref TS 23.280 v 15.2.0.

According to aspects, the method comprises performing Sa2 a registration procedure involving the GC client 310 according to 3GPP Mission Critical common architecture framework, TS 23.280 v 15.3.0.

According to aspects, the method comprises receiving Sa3 a group affiliation request associated with the GC client 310.

According to aspects, the method comprises handling Say GC involving the GC client 310 by the central participating function 112 and the central controlling function 113 if the GC client is not in proximity of a GC capable RBS 120 executing the local participating function 231.

According to aspects, a GC capable RBS 120 is an Isolated E-UTRAN operations for Public Safety, IOPS, capable RBS.

According to aspects, obtaining information comprises obtaining any of a geographical location in terms of coordinates, an identity of a serving network node or RBS, a service or tracking area identity, a list of RBSs in proximity of a wireless device 140 associated with the GC client 310, an IP address, MAC address or network structure data associated with the wireless device 140. Thus, it is appreciated that the concept of proximity is to be given a broad meaning beyond physical distance.

According to aspects, the method comprises requesting re-registration Sa6 involving the GC client 310 and the GC capable RBS 120 if the GC client is in proximity of the GC capable RBS 120. This way the GC server node may prompt the GC client to re-register. For instance, a request for re-registration can be issued when traffic overload is experienced at the central node, or when an indication has been obtained about an imminent link failure. By issuing requests for re-registration, some complexity can also be removed from the GC client, which then need not decide to re-register, but can wait for the request.

According to aspects, releasing the central participating function 112 comprises obtaining Sa81 confirmation that a local participating function 231 is executed by the GC capable RBS 120 prior to releasing the central participating function 112. The confirmation provides for some robustness in that the releasing does not take place until confirmation has been obtained.

The obtaining confirmation may be achieved in different ways. For instance, according to some aspects, obtaining confirmation comprises receiving a message from the GC capable RBS 120 indicating that the local participating function 231 has been activated in the local GC server 230.

According to some other aspects, obtaining confirmation comprises receiving a de-registration message associated with the GC client 310.

According to some further aspects, obtaining confirmation comprises receiving information indicating that the GC client 310 has registered with the GC capable RBS 120 and that the GC capable RBS 120 is executing the local participating function 231 prior to releasing the central participating function 112.

The ways of obtaining confirmation discussed above are compatible. A system may one or more confirmation mechanisms in parallel.

FIG. 7 is a flow chart illustrating a method in a wireless device 140 comprising a GC client 310, such as the GC client discussed above in connection to FIGS. 1-5. The method comprises obtaining Sb1 information indicating whether the GC client 310 is in proximity of a GC capable radio base station 120, RBS, comprising a local GC server 230. The method comprises, if the GC client is in proximity of the GC capable RBS, performing Sb2 a GC registration procedure involving the GC client 310 and the local GC server 230.

The methods performed in the wireless device match those performed in the central GC server discussed above.

According to aspects, the performing Sb2 comprises performing Sb21 an authentication procedure.

According to aspects, the method comprises transmitting Sb3 a group affiliation request associated with the GC client 310 to the local GC server 230.

According to aspects, the method comprises receiving Sb4 a request for re-registration involving the GC client 310 and the local GC server 230 from a central GC server 111, wherein the performing of a GC registration procedure involving the GC client 310 and the local GC server 230 is executed in response to receiving the request for re-registration.

According to aspects, the method comprises performing Sb5 a handshake procedure for group communication involving the GC client 310 and the local GC server 230 following a link outage between the local GC server 230 and the central GC server 111, or between the GC client 310 and the central GC server 111.

One way to perform the handshake procedure is to perform a transition procedure which comprises activating the local control function in the GC server to perform GC.

According to aspects, the group communication capability is an Isolated E-UTRAN operations for Public Safety, IOPS, capability.

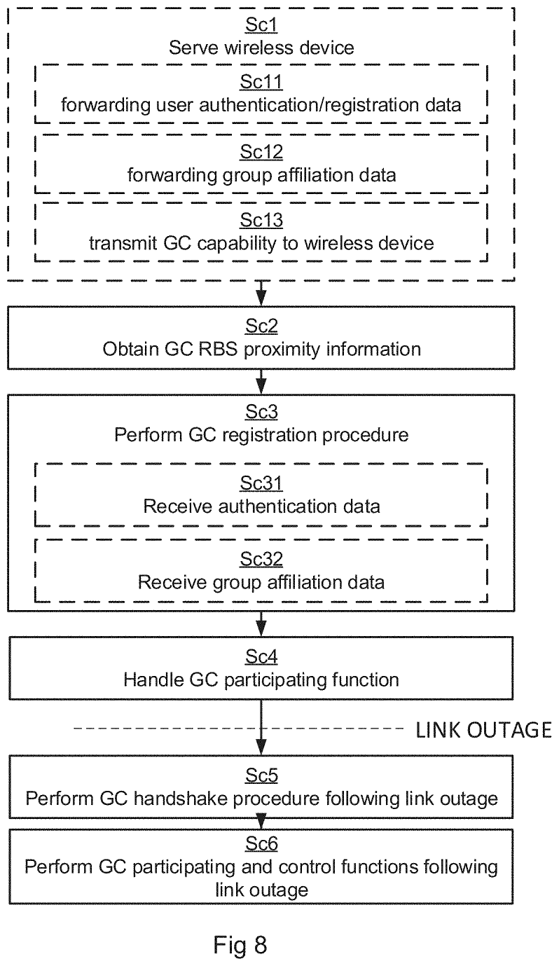

FIG. 8 is a flow chart illustrating a method in a local GC capable RBS comprising a local GC server 230, wherein the local GC server comprises a local participating function 231 and a local controlling function 232 for GC involving a GC client 310 comprised in a wireless device 140. The method comprises obtaining Sc2 information indicating whether the GC client 310 is in proximity of the GC capable RBS 120, and, if the GC client is in proximity of the GC capable RBS, performing Sc3 a GC registration procedure involving the GC client 310 and the local GC server 230, and also handling Sc4 GC involving the GC client 310 by the local participating function 231. The method also comprises, following a link outage between the local GC server and a central GC server 111, or between the GC client 310 and the central GC server 111, performing Sc5 a handshake procedure for group communication involving the GC client 310 and the local GC server 230, and handling Sc6 GC involving the GC client 310 by the local participating function 231 and the local controlling function 232.

The methods performed in the local GC capable RBS match those performed in the central GC server and in the wireless device discussed above.

According to aspects, the GC capable RBS 120 comprises an evolved NodeB 210, eNB, a local Evolved Packet Core 220, EPC, and the local GC server 230.

According to aspects, the method comprises transmitting Sc13 an indication to the wireless device 140 relating to a GC capability of the GC capable RBS 120.

According to aspects, the GC capability is an Isolated E-UTRAN operations for Public Safety, IOPS, capability.

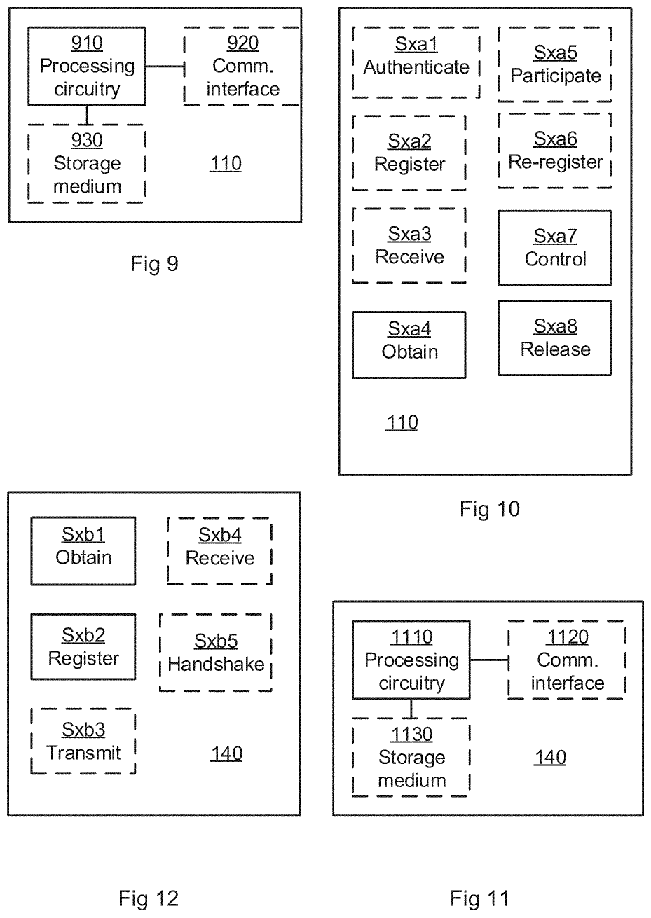

FIGS. 9-10 schematically illustrate a server node 110 according to aspects of the present disclosure. It is appreciated that the above described methods may be realized in hardware. This hardware is then arranged to perform the methods, whereby the same advantages and effects are obtained as have been discussed above.

FIG. 9 schematically illustrates, in terms of a number of functional units, the components of a GC server node 110 hardware according to an embodiment of the above discussions. Processing circuitry 910 is provided using any combination of one or more of a suitable central processing unit CPU, multiprocessor, microcontroller, digital signal processor DSP, etc., capable of executing software instructions stored in a computer program product, e.g. in the form of a storage medium 930. The processing circuitry 910 may further be provided as at least one application specific integrated circuit ASIC, or field programmable gate array FPGA.

Particularly, the processing circuitry 910 is configured to cause the GC server node 110 to perform a set of operations, or steps. For example, the storage medium 930 may store the set of operations, and the processing circuitry 910 may be configured to retrieve the set of operations from the storage medium 930 to cause the GC server node 110 to perform the set of operations. The set of operations may be provided as a set of executable instructions. Thus, the processing circuitry 910 is thereby arranged to execute methods as herein disclosed.

The storage medium 930 may also comprise persistent storage, which, for example, can be any single one or combination of magnetic memory, optical memory, solid state memory or even remotely mounted memory.

The GC server node 110 may further comprise a communications interface 920 for communications with at least one external device. As such the communication interface 920 may comprise one or more transmitters and receivers, comprising analogue and digital components and a suitable number ports for wireline or wireless communication.

The processing circuitry 910 controls the general operation of the node 110 e.g. by sending data and control signals to the communication interface 920 and the storage medium 930, by receiving data and reports from the communication interface 920, and by retrieving data and instructions from the storage medium 930. Other components, as well as the related functionality, of the node 110 are omitted in order not to obscure the concepts presented herein.

With reference also to FIG. 1, FIG. 10 schematically illustrates a GC server node 110 comprising a central GC server 111, wherein the central GC server comprises a central participating function 112 and a central controlling function 113 for GC involving a GC client 310. The GC server node corresponds to the GC server node discussed above in connection to FIG. 6. The GC server node comprises
an obtaining module Sax4 arranged to obtain information indicating whether the GC client 310 is in proximity of a GC capable radio base station 120, RBS, and, if the GC client is in proximity of the GC capable RBS;
a controlling module Sax7 arranged to handle GC involving the GC client 310 by the central controlling function 113, and
a release module Sax8 arranged to release the central participating function 112 to the GC capable RBS 120 that is adapted to execute a local participating function 231.

According to aspects, the GC server node 110 comprises an authentication module Sax1 arranged to perform an authentication procedure involving the GC client 310.

According to aspects, the GC server node 110 comprises a registration module Sax2 arranged to perform a registration procedure involving the GC client 310 according to 3GPP Mission Critical common architecture framework, TS 23.280 v 15.3.0.

According to aspects, the GC server node 110 comprises a receive module Sax3 arranged to receive a group affiliation request associated with the GC client 310.

According to aspects, the GC server node 110 comprises a participating module Sax5 arranged to handle GC involving the GC client 310 by the central participating function 112 and the central controlling function 113 if the GC client is not in proximity of a GC capable RBS 120 executing the local participating function 231.

According to aspects, the GC server node 110 comprises a re-registration module Sax6 arranged to request re-registration involving the GC client 310 and the GC capable RBS 120 if the GC client is in proximity of the GC capable RBS 120.

FIG. 11 schematically illustrates, in terms of a number of functional units, the components of a wireless device 140 according to an embodiment of the above discussions. Processing circuitry 1110 is provided using any combination of one or more of a suitable central processing unit CPU, multiprocessor, microcontroller, digital signal processor DSP, etc., capable of executing software instructions stored in a computer program product, e.g. in the form of a storage medium 1130. The processing circuitry 1110 may further be provided as at least one application specific integrated circuit ASIC, or field programmable gate array FPGA.

Particularly, the processing circuitry 1110 is configured to cause the Wireless device 140 to perform a set of operations, or steps. For example, the storage medium 1130 may store the set of operations, and the processing circuitry 1110 may be configured to retrieve the set of operations from the storage medium 1130 to cause the Wireless device 140 to perform the set of operations. The set of operations may be provided as a set of executable instructions. Thus, the processing circuitry 1110 is thereby arranged to execute methods as herein disclosed.

The storage medium 1130 may also comprise persistent storage, which, for to example, can be any single one or combination of magnetic memory, optical memory, solid state memory or even remotely mounted memory,

The Wireless device 140 may further comprise a communications interface 1120 for communications with at least one external device. As such the communication interface 1120 may comprise one or more transmitters and receivers, comprising analogue and digital components and a suitable number ports for wireline or wireless communication.

The processing circuitry 1110 controls the general operation of the device 140 e.g. by sending data and control signals to the communication interface 1120 and the storage medium 1130, by receiving data and reports from the communication interface 1120, and by retrieving data and instructions from the storage medium 1130. Other components, as well as the related functionality, of the device 140 are omitted in order not to obscure the concepts presented herein.

FIG. 12 schematically illustrates a wireless device 140 comprising a Group Communication, GC, client 310. The wireless device 140 corresponds to the wireless device discussed above in connection to FIG. 7. The wireless device comprises;
an obtaining module Sbx1 arranged to obtain information indicating whether the GC client 310 is in proximity of a GC capable radio base station 120, RBS, comprising a local GC server 230, and;
a registration module Sbx2 arranged to determine if the GC client is in proximity of a GC capable RBS, and to perform a GC registration procedure involving the GC client 310 and the local GC server 230 if the GC client is in proximity of a GC capable RBS.

According to aspects, the wireless device comprises a transmit module Sbx3 arranged to transmit a group affiliation request associated with the GC client 310 to the local GC server 230.

According to aspects, the wireless device comprises receive module Sbx4 arranged to receive a request for re-registration involving the GC client 310 and the local GC server 230 from a central GC server 111, wherein the performing of a GC registration procedure involving the GC client 310 and the local GC server 230 is executed in response to receiving the request for re-registration.

According to aspects, the wireless device comprises a handshake module Sbx5 arranged to perform a handshake procedure for group communication involving the GC client 310 and the local GC server 230 following a link outage between the local GC server 230 and the central GC server 111, or between the GC client 310 and the central GC server 111.

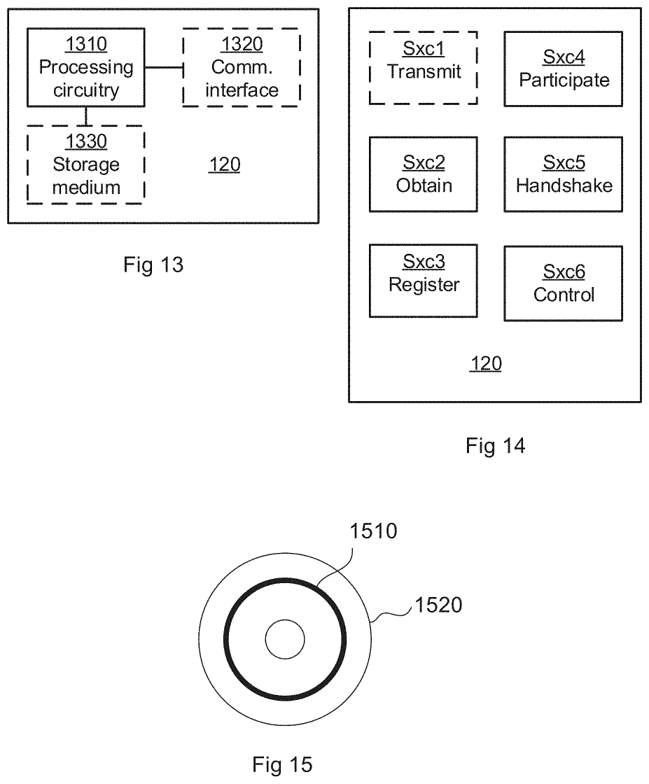

FIG. 13 schematically illustrates, in terms of a number of functional units, the components of a Local GC server node 120 according to an embodiment of the above discussions. Processing circuitry 1310 is provided using any combination of one or more of a suitable central processing unit CPU, multiprocessor, microcontroller, digital signal processor DSP, etc., capable of executing software instructions stored in a computer program product, e.g. in the form of a storage medium 1330. The processing circuitry 1310 may further be provided as at least one application specific integrated circuit ASIC, or field programmable gate array FPGA.

Particularly, the processing circuitry 1310 is configured to cause the Local GC server node 120 to perform a set of operations, or steps. For example, the storage medium 1330 may store the set of operations, and the processing circuitry 1310 may be configured to retrieve the set of operations from the storage medium 1330 to cause the Local GC server node 120 to perform the set of operations. The set of operations may be provided as a set of executable instructions. Thus, the processing circuitry 1310 is thereby arranged to execute methods as herein disclosed.

The storage medium 1330 may also comprise persistent storage, which, for example, can be any single one or combination of magnetic memory, optical memory, solid state memory or even remotely mounted memory.

The Local GC server node 120 may further comprise a communications interface 1320 for communications with at least one external device. As such the communication interface 1320 may comprise one or more transmitters and receivers, comprising analogue and digital components and a suitable number ports for wireline or wireless communication.

The processing circuitry 1310 controls the general operation of the node 120 e.g. by sending data and control signals to the communication interface 1320 and the storage medium 1330, by receiving data and reports from the communication interface 1320, and by retrieving data and instructions from the storage medium 1330. Other components, as well as the related functionality, of the node 120 are omitted in order not to obscure the concepts presented herein.

FIG. 14 schematically illustrates a local GC capable RBS 120 comprising a local GC server 230. The local GC capable RBS corresponds to the local GC capable RBS discussed in connection to, e.g., FIG. 8 above. The local GC server comprises a local participating function 231 and a local controlling function 232 for GC involving a GC client 310 comprised in a wireless device 140. The local GC capable radio base station comprises;
an obtain module Scx2 arranged to obtain information indicating whether the GC client 310 is in proximity of the GC capable RBS 120, and, if the GC client is in proximity of the GC capable RBS;
a registration module Scx3 arranged to perform a GC registration procedure involving the GC client 310 and the local GC server 230,
a participate module Scx4 arranged to handle GC involving the GC client 310 by the local participating function 231, and
a handshake module Scx5 arranged to, following a link outage between the local GC server and a central GC server 111, or between the GC client 310 and the central GC server 111, perform a handshake procedure for group communication involving the GC client 310 and the local GC server 230, and
a control module Scx6 arranged to handle GC involving the GC client 310 by the local controlling function 232.

According to aspects, the local GC capable RBS 120 comprises an evolved NodeB 210, eNB, a local Evolved Packet Core 220, EPC, and the local GC server 230.

According to aspects, the local GC capable RBS 120 comprises a transmit module Scx1 arranged to transmit an indication to the wireless device 140 relating to a GC capability of the GC capable RBS 120.

FIG. 15 schematically illustrates a computer readable medium 1520. The various aspects of the methods and techniques described herein are described in the general context of method steps or processes, which may be implemented in one aspect by a computer program product 1510, embodied in a computer-readable medium 1520, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc., that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

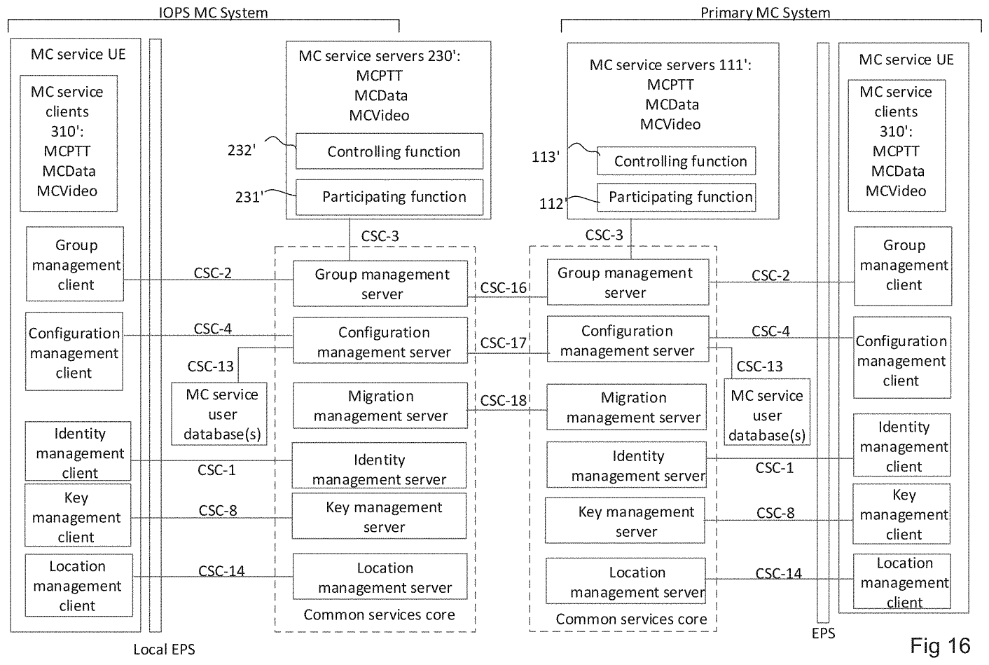

Some aspects of the above discussion comprise a solution for switching between Primary and Isolated E-UTRAN Operations for Public Safety (TOPS) Mission Critical (MC) systems, An example functional model of an IOPS MC system is illustrated in FIG. 16. For simplicity some of the internal reference points are not illustrated in the FIG. 16.

In this context, a GC client 310 is according to some aspects an MC service client 310′, a local GC server 230 is according to some aspects an MC service server 230′ or an IOPS MC service server. In this context, the primary MC system comprises the central GC server 110, and the IOPS MC system comprises to the local GC server 230.

One architectural solution for an IOPS MC system is to have a fully functional and active MC system used during normal operations. In the IOPS MC system the MC service server 230′ only execute the participating role 231′ during normal operating conditions and the primary MC system execute the controlling role 113′. When the connection between the IOPS MC system and the Primary system breaks 401 the IOPS MC system executes both participating 231′ and controlling 232′ roles of the MC service server.

In the functional model shown in FIG. 16, the users may be transferred to the IOPS MC system and actively use the MC service servers participating function 231′. This trigger to transfer the users may be based on the UE location and the MC service provider policy, and by that receive part of the MC services from the IOPS MC system. This takes place prior to that the IOPS mode is triggered by backhaul failure.

This solution provides a minor deviation from the functional model in a primary MC system. A few functional entities and reference points can be removed since they are not needed in the IOPS MC system. The users using the IOPS MC system need to switch to use the participating function of the MC service server in the IOPS MC system prior to the transition to IOPS mode, User and service data synchronization is limited to users that are using the IOPS MC system prior to a backhaul failure. There may be an issue in providing service to users who have not been transferred to the IOPS MC system prior to the backhaul failure as their configuration data will not be accessible during the backhaul failure. For these users there must be another data synchronization solution in place prior these users may enjoy MC services in lops mode. Some of the procedures discussed herein comprises the MC service client being triggered to re-register to the IOPS MC system and use the participating function in the MC service server in the IOPS MC system and the controlling function in the MC service server in the primary MC system.

FIG. 4, discussed above, illustrates one procedure for switching an MC service client from the primary MC system to the IOPS MC system. It requests the user to re-register in the IOPS MC system, while keeping part of the functionality (the controlling function) in the primary MC system.

Pre-conditions may comprise that:
The MC service client is authenticated and authorized 410 by the primary MC system 110.
The MC service client is registered 410 in the primary MC system 110.
The MC service client has affiliated to one or several MC service groups 420.

The procedure illustrated in FIG. 4, according to some aspects comprises;

430: Group communication is handled by the primary MC system solely.

431. The MC client or the MC service server in the primary MC system detects that the MC client is in proximity of an IOPS MC system. How this is detected is implementation specific. It is appreciated that 431 could be triggered by detecting that the cell that the UE is currently attached to is IOPS capable or that the MC service server knows that a neighboring cell to the currently attached cell is IOPS capable.

440: In the scenario that the MC service server in the primary MC system decides that the MC services client shall be transferred to the IOPS MC system, the MC service server sends a re-registration request to the MC service client.

450: The MC service client performs the authentication and registration procedure as defined in 3GPP TS 23.280.

460: The MC service client affiliates to the MC service groups of interest, that request for affiliation is forwarded to the controlling function in the MC service server both in the IOPS MC system and the primary MC system.

470: Group communication is handled by the participating function in the IOPS MC system and the controlling function in the primary MC system.

401: The connectivity between the IOPS MC system and the primary MC system breaks.

480: Group communication is handled by the IOPS MC system solely.

When the connectivity between the IOPS MC system and primary MC system is restored the group communication may continue, utilizing the primary MC systems controlling function. In this case any group affiliations that was done during IOPS mode must be forwarded to the primary MC system's MC service server.

This solution provides an efficient way to transfer ongoing calls from a primary MC system to an IOPS MC system when there is a failure in the connectivity between the IOPS MC system and the primary MC system. Users that has not been transferred to the IOPS MC system prior the failure may need to perform the authentication procedures according to 3GPP TS 23.280 before accessing the service.

1-35. (canceled)

36. A method in a Group Communications (GC) server node comprising a central GC server, wherein the central GC server comprises a central participating function and a central controlling function for GC involving a GC client, the method comprising:
obtaining information indicating whether the GC client is in proximity to a GC capable radio base station (RBS); and
if the GC client is in proximity to the GC capable RBS:
handling GC involving the GC client by the central controlling function; and
releasing the central participating function to the GC capable RBS that is adapted to execute a local participating function.

37. The method of claim 36, further comprising performing an authentication procedure involving the GC client.

38. The method of claim 36, further comprising performing a registration procedure involving the GC client according to 3GPP Mission Critical common architecture framework, TS 23.280 v 15.3.0.

39. The method of claim 36, further comprising receiving a group affiliation request associated with the GC client.

40. The method of claim 36, further comprising handling GC involving the GC client by the central participating function and the central controlling function if the GC client is not in proximity to a GC capable RBS executing the local participating function.

41. The method of claim 36, wherein obtaining information comprises obtaining any of:
a geographical location in terms of coordinates;
an identity of a serving network node or RBS;
a service or tracking area identity;
a list of RBSs in proximity to a wireless device associated with the GC client;
an IP address, MAC address, or network structure data associated with the wireless device.

42. The method of claim 36, further comprising requesting re-registration involving the GC client and the GC capable RBS if the GC client is in proximity to the GC capable RBS.

43. The method claim 36, wherein the releasing the central participating function comprises obtaining confirmation that a local participating function is executed by the GC capable RBS prior to releasing the central participating function.

44. The method of claim 43, wherein the obtaining confirmation comprises receiving a message from the GC capable RBS indicating that the local participating function has been activated in the local GC server.

45. The method of claim 43, wherein the obtaining confirmation comprises receiving a de-registration message associated with the GC client.

46. The method of claim 43, wherein the obtaining confirmation comprises receiving information indicating that the GC client has registered with the GC capable RBS and that the GC capable RBS is executing the local participating function prior to releasing the central participating function.

47. A method in a wireless device comprising a Group Communication (GC) client, the method comprising;
obtaining information indicating whether the GC client is in proximity to a GC capable radio base station (RBS) comprising a local GC server; and
if the GC client is in proximity to a GC capable RBS, performing a GC registration procedure involving the GC client and the local GC server.

48. The method of claim 47, wherein the performing the GC registration procedure comprises performing an authentication procedure.

49. The method of claim 47, further comprising transmitting a group affiliation request associated with the GC client to the local GC server.

50. The method of claim 47, further comprising receiving a request for re-registration involving the GC client and the local GC server from a central GC server, wherein the performing of a GC registration procedure involving the GC client and the local GC server is executed in response to receiving the request for re-registration.

51. The method of claim 47, further comprising performing a handshake procedure for group communication involving the GC client and the local GC server following a link outage between the local GC server and the central GC server, or between the GC client and the central GC server.

52. A method in a local Group Communications (GC) capable radio base station (RBS) comprising a local GC server, wherein the local GC server comprises a local participating function and a local controlling function for GC involving a GC client comprised in a wireless device, the method comprising:
obtaining information indicating whether the GC client is in proximity to the GC capable RBS; and
if the GC client is in proximity to the GC capable RBS:
performing a GC registration procedure involving the GC client and the local GC server;
handling GC involving the GC client by the local participating function; and
following a link outage between the local GC server and a central GC server, or between the GC client and the central GC server:
performing a handshake procedure for group communication involving the GC client and the local GC server; and
handling GC involving the GC client by the local participating function and the local controlling function.

53. The method of claim 52, further comprising transmitting an indication to the wireless device relating to a GC capability of the GC capable RBS.

54. A Group Communications (GC) server node, comprising:
a central GC server, wherein the central GC server comprises a central participating function and a central controlling function for GC involving a GC client;
processing circuitry;
memory containing instructions executable by the processing circuitry whereby the GC server node is operative to:
obtain information indicating whether the GC client is in proximity to a GC capable radio base station (RBS); and
if the GC client is in proximity to the GC capable RBS:
handle GC involving the GC client by the central controlling function; and
release the central participating function to the GC capable RBS that is adapted to execute a local participating function.

55. A wireless device, comprising:
a Group Communication (GC) client
processing circuitry;
memory containing instructions executable by the processing circuitry whereby the wireless device is operative to:
obtain information indicating whether the GC client is in proximity to a GC capable radio base station (RBS) comprising a local GC server; and
determine if the GC client is in proximity to a GC capable RBS; and
perform a GC registration procedure involving the GC client and the local GC server if the GC client is in proximity to a GC capable RBS.

56. The wireless device of claim 55, wherein the instructions are such that the wireless device is operative to transmit a group affiliation request associated with the GC client to the local GC server.

57. The wireless device of claim 55, wherein the instructions are such that the wireless device is operative to:
receive a request for re-registration involving the GC client and the local GC server from a central GC server
perform the GC registration procedure involving the GC client and the local GC server in response to receiving the request for re-registration.

58. The wireless device of claim 55, wherein the instructions are such that the wireless device is operative to perform a handshake procedure for group communication involving the GC client and the local GC server following a link outage between the local GC server and the central GC server, or between the GC client and the central GC server.
